(19) United States
(12) Patent Application Publication
(10) Pub. No.: US 2005/0235069 A1
(43) Pub. Date: Oct. 20, 2005

(54) Microcontroller

(75) Inventors: Hirokazu Miwa, Kawasaki (JP); Yasuyuki Hori, Kawasaki (JP); Hiroyoshi Yamashita, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 10/949,300

(22) Filed: Sep. 27, 2004

(30) Foreign Application Priority Data
Apr. 20, 2004 (JP) 2004-123881

(51) Int. Cl. G06F 13/14

(52) U.S. Cl. 710/8

(57) ABSTRACT

An external port control register of an input/output port outputs a setting value signal indicating a setting value in order that either a general-purpose input/output port function or a functional block input/output pin function is set to an external pin. A selector of the input/output port connects either a general output path or an output path of a functional block receiving a functional block input signal, to the external pin according to the setting value signal. An interrupting circuit interrupts the supply of the functional block input signal to the functional block when the setting value signal indicates the general-purpose input/output port function. Consequently, any register circuit designating whether to enable or disable the supply of the functional block input signal to the functional block need not be provided in particular, which can eliminate the need for a redundant setting process in switching the pin function of the external pin.

### CROSS-REFERENCE TO RELATED APPLICATIONS

This application is based upon and claims the benefit of priority from Japanese Patent Application No. 2004-123881, filed on Apr. 20, 2004, the entire contents of which are incorporated herein by reference.

### BACKGROUND OF THE INVENTION

1. Field of the Invention

The present invention relates to a microcontroller, and more particularly to a microcontroller having multiplexed external pins for functioning as both general-purpose input/output ports and resource input/output pins (functional block input/output pins).

2. Description of the Related Art

In a microcontroller having a multiplexed external pin, the multiplexed external pin is switched between a general-purpose input/output port function and a resource input/output pin function based on the setting value of an external port control register (EPCR) which is formed in an input/output port. That is, the multiplexed external pin functions as a general-purpose input/output port or a resource input/output pin according to the setting value of the EPCR.

The input/output port has a data direction register (DDR) for setting the input/output mode of the multiplexed external pin, and a port data register (PDR) to which data to be supplied to the multiplexed external pin is set when the multiplexed external pin is used as a general-purpose input/output port. When the setting value of the DDR indicates the input mode, the voltage level applied to the multiplexed external pin from exterior is transmitted to a CPU via an internal bus. When the setting value of the EPCR indicates the general-purpose input/output port function and the setting value of the DDR indicates the output mode, the data set in the PDR is supplied to the multiplexed external pin. When the setting value of the EPCR indicates the resource input/output pin function and the setting value of the DDR indicates the output mode, a resource output signal output from a resource is supplied to the multiplexed external pin. Moreover, a resource input signal supplied via the multiplexed external pin is supplied from the input/output port to the resource, regardless of the setting values of the respective registers in the input/output port.

In a microcontroller having such a configuration, when, for example, the setting value of the EPCR indicates the general-purpose input/output port function and the setting value of the DDR indicates the output mode, the data set in the PDR is supplied to the multiplexed external pin and can also be supplied to the resource as the resource input signal. Thus, in order to prevent the resource from malfunctioning due to the unnecessary supply of the resource input signal to the resource, a register circuit for holding information that indicates whether to enable or disable the supply of the resource input signal to the resource is provided in the resource, aside from the EPCR of the input/output port. Information that indicates of disabling the supply of the resource input signal to the resource can be written to the register circuit so that the resource is prevented from malfunctioning due to the unnecessary supply of the resource input signal to the resource.

Moreover, Japanese Unexamined Patent Application Publication No. Hei 5-250079 discloses a technology for preventing data previously set in the PDR from being changed accidentally within the input/output port because of data transmitted from the external pin (general-purpose input/output port) to the internal bus.

### SUMMARY OF THE INVENTION

An object of the present invention is to interrupt the supply of the functional block input signal to the functional block with a simple circuit configuration when the external pin is used as a general-purpose input/output port.

According to one of the aspects of the microcontroller of the present invention, a functional block receives a functional block input signal supplied via an external pin. An input/output port has an external port control register and a selector. The external port control register outputs a setting value signal indicating a setting value in order that either a general-purpose input/output port function or a functional block input/output pin function is set to the external pin. The selector connects either a general output path or an output path of the functional block to the external pin according to the setting value signal output from the external port control register. An interrupting circuit receives the setting value signal output from the external port control register, and interrupts supply of the functional block input signal to the functional block when the setting value signal indicates the general-purpose input/output port function.

In the microcontroller having such a configuration, the setting value signal output from the external pin setting register is used directly to interrupt the supply of the functional block input signal to the functional block. Consequently, any register circuit for designating whether to enable or disable the supply of the functional block input signal to the functional block need no longer be provided in the functional block. This can eliminate the need for a redundant setting process in switching the pin function of the external pin. As a result, user programs can be simplified with a reduction of program errors by users.

According to another aspect of the microcontroller of the present invention, the interrupting circuit includes a gate circuit. The gate circuit masks the functional block input signal supplied to the functional block while receiving the setting value signal indicating the general-purpose input/output port function. The supply of the functional block input signal to the functional block can thus be interrupted with a simple circuit configuration.

According to another aspect of the microcontroller of the present invention, the interrupting circuit includes a flip-flop. The flip-flop accepts the functional block input signal and supplies the accepted functional block input signal to the functional block while receiving the setting value signal indicating the functional block input/output pin function. Moreover, the flip-flop stops the operation of accepting the functional block input signal while receiving the setting value signal indicating the general-purpose input/output port function. That is, when the setting value signal output from the external port control register indicates the general-purpose input/output port function, the supply of the functional block input signal to the functional block is interrupted. The supply of the functional block input signal to the functional block can thus be interrupted with a simple circuit configuration.

In addition, the functional block typically has a flip-flop for synchronizing the functional block input signal with an internal clock, and the signal synchronized with the internal clock by the flip-flop is used as the functional block input signal. In such cases, according to the present invention, the flip-flop for synchronizing the functional block input signal with the internal block can also be operated as the interrupting circuit. It is therefore possible to suppress an increase in circuit scale resulting from the incorporation of an interrupting circuit.

According to another aspect of the microcontroller of the present invention, the interrupting circuit includes a flip-flop and a gate circuit. The flip-flop accepts the functional block input signal in synchronization with an internal clock, and supplies the accepted functional block input signal to the functional block. The gate circuit masks the internal clock supplied to the flip-flop while receiving the setting value signal indicating the general-purpose input/output port function. Consequently, when the setting value signal output from the external port control register indicates the general-purpose input/output port function, the flip-flop stops the operation of accepting the functional block input signal. That is, when the setting value signal output from the external port control register indicates the general-purpose input/output port function, the supply of the functional block input signal to the functional block is interrupted. The supply of the functional block input signal to the functional block can thus be interrupted with a simple circuit configuration.

Moreover, the flip-flop for synchronizing the functional block input signal with the internal clock, when combined with the gate circuit for masking the internal clock, can also be operated as the interrupting circuit. This can suppress an increase in circuit scale resulting from the incorporation of an interrupting circuit. Furthermore, since the supply of the internal clock to the flip-flop is interrupted when the setting value signal output from the external port control register indicates the general-purpose input/output port function, it is possible to suppress the power consumption of the microcontroller while the external pin is used as the general-purpose input/output port.

According to another aspect of the microcontroller of the present invention, a CPU is connected to the external port control register via an internal bus. The setting value of the external port control register is set by the CPU. The setting value of the external port control register can thus be set easily.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a block diagram showing a first embodiment of the microcontroller of the present invention;

FIG. 2 is a block diagram showing the details of the resources and the input/output ports according to the first embodiment;

FIG. 3 is an explanatory diagram showing the relationship between the register setting values of the input/output ports and the pin functions of the external pins;

FIG. 4 is a block diagram showing a microcontroller reviewed before the present invention;

FIG. 5 is a block diagram showing a second embodiment of the microcontroller of the present invention; and

FIG. 6 is a block diagram showing a third embodiment of the microcontroller of the present invention.

### DESCRIPTION OF THE PREFERRED EMBODIMENTS

The present invention has been achieved to solve the following problem.

In the microcontroller previously described, the register circuit for designating whether to enable or disable the supply of the resource input signal to the resource is provided aside from the EPCR. Thus, in switching the pin function of the multiplexed external pin, whether to enable or disable the supply of the resource input signal to the resource must be set by using the register circuit before the setting value of the EPCR is changed. That is, the provision of the special register circuit for designating whether to enable or disable the supply of the resource input signal to the resource requires a redundant setting process. This has produced the problem that programs to be executed by the CPU become complicated with an increase of program errors by users.

Hereinafter, embodiments of the present invention will be described with reference to the drawings.

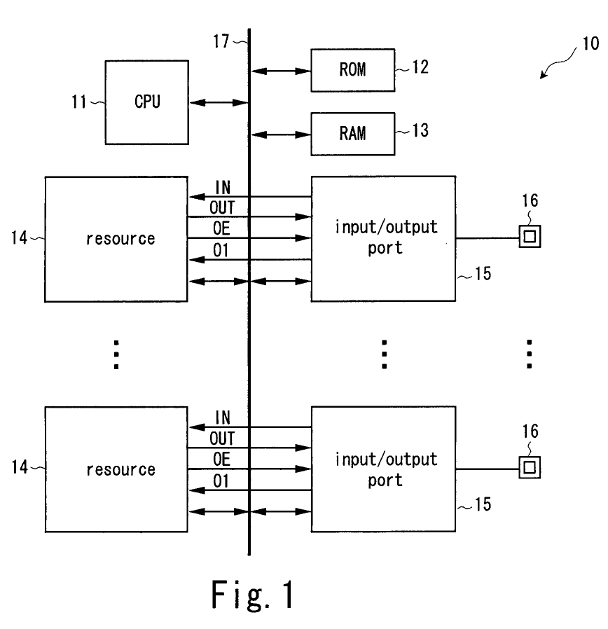

FIG. 1 shows a first embodiment of the microcontroller of the present invention. The microcontroller 10 includes: a CPU 11; a ROM 12 which contains programs to be executed by the CPU 11; a RAM 13 which temporarily stores various types of data such as results of operation of the CPU 11; a plurality of resources 14 (functional blocks); a plurality of input/output ports 15 corresponding to the resources 14, respectively; a plurality of external pins 16 which are connected to the input/output ports 15, respectively, and function as both general-purpose input/output ports and resource input/output pins; and an internal bus 17. The CPU 11, the ROM 12, the RAM 13, the resources 14, and the input/output ports 15 are connected with each other via the internal bus 17, and thus can exchange data therebetween.

The resources 14 are peripheral modules such as a timer. They receive resource input signals IN (for example, a timer start signal for starting a timer) supplied from exterior via the external pins 16 and the input/output ports 15. Incidentally, the supply of the resource input signals IN (functional block input signals) into the resources 14 is enabled/disabled depending on setting value signals 01 which are output from EPCR 151 of the input/output ports 15 to be described later. Moreover, the resources 14 supply the input/output ports 15 with resource output signals OUT (for example, a compare-match signal for indicating that a timer count reaches a predetermined value) and resource output enabling signals OE for enabling/disabling the output of the resource output signals OUT to exterior.

The input/output ports 15 supply the internal bus 17 with signals supplied from exterior via the external pins 16 or supply the external pins 16 with data set by the CPU 11 when the external pins 16 are used as general-purpose input/output ports. Moreover, when the external pins 16 are used as resource input/output pins, the input/output ports 15 supply the resources 14 with signals supplied from exterior via the external pins 16 as the resource input signals IN, or supply the external pins 16 with the resource output signals OUT while the resource output enabling signals OE are activated.

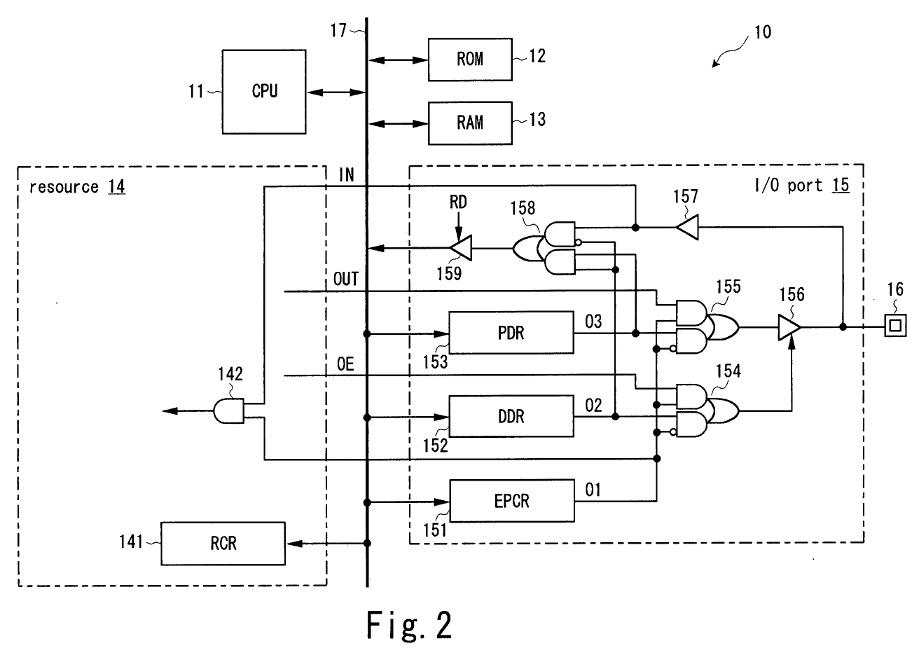

FIG. 2 shows the details of the resources 14 and the input/output ports 15 according to the first embodiment. An input/output port 15 includes: an EPCR 151 (external port control register) which sets the pin function of the external pin 16 (either a general-purpose input/output port function or a resource input/output pin function); a DDR 152 (data direction register) which sets the input/output mode of the external pin 16; a PDR 153 (port data register) into which data to be supplied to the external pin 16 is set when the external pin 16 is used as a general-purpose input/output port; selectors 154 and 155; an output buffer 156; an input buffer 157; a selector 158; and a buffer 159.

The EPCR 151 is composed of, for example, a flip-flop having its data input terminal connected to the internal bus 17. It accepts data supplied from the CPU 11 to the internal bus 17 in response to a write signal (not shown) supplied to the EPCR 151. The EPCR 151 outputs the accepted data as a setting value signal O1 via its data output terminal. Incidentally, the setting value of the EPCR 151 is set at “0” when the external pin 16 is used as a general-purpose input/output port, and set at “1” when the external pin 16 is used as a resource input/output pin. Consequently, the setting value signal O1 output from the EPCR 151 is fixed to “0” when the external pin 16 is used as a general-purpose input/output port, and fixed to “1” when the external pin 16 is used as a resource input/output pin.

Similarly, the DDR 152 and the PDR 153 are composed of, for example, flip-flops having their data input terminals connected to the internal bus 17, respectively. They accept data supplied from the CPU 11 to the internal bus 17 in response to a write signal supplied to the DDR 152 and a write signal (not shown) supplied to the PDR 153, respectively. The DDR 152 and the PDR 153 output the accepted data as setting value signals O2 and O3 via their data output terminals, respectively. Incidentally, the setting value of the DDR 152 is set at “0” when the external pin 16 is used in an input mode, and set at “1” when the external pin 16 is used in an output mode. Consequently, the setting value signal O2 output from the DDR 152 is fixed to “0” when the external pin 16 is used in the input mode, and fixed to “1” when the external pin 16 is used in the output mode.

The selector 154 supplies the output buffer 156 with the resource output enabling signal OE output from the resource 14 when the setting value signal O1 output from the EPCR 151 is “1”. The selector 154 also supplies the output buffer 156 with the setting value signal O2 output from the DDR 152 when the setting value signal O1 output from the EPCR 151 is “0”. The selector 155 supplies the output buffer 156 with the resource output signal OUT output from the resource 14 when the setting value signal O1 output from the EPCR 151 is “1”. The selector 155 also supplies the output buffer 156 with the setting value signal O3 output from the PDR 153 when the setting value signal O1 output from the EPCR 151 is “0”. The output buffer 156 supplies the external pin 16 with the output signal of the selector 155 when the output signal of the selector 154 is “1”.

Consequently, when the setting value signal O1 output from the EPCR 151 is “1” (i.e., when the external pin 16 is used as a resource input/output pin) and the resource output enabling signal OE is “1”, the resource output signal OUT is supplied to the external pin 16. When the setting value signal O1 output from the EPCR 151 is “0” (i.e., when the external pin 16 is used as a general-purpose input/output port) and the setting value signal 02 output from the DDR 152 is “1” (i.e., when the external pin 16 is used in the output mode), the setting value signal O3 output from the PDR 153 (i.e., the data set in the PDR 153) is supplied to the external pin 16.

The selector 158 supplies the buffer 159 with the setting value signal O3 output from the PDR 153 when the setting value signal O2 output from the DDR 152 is “1”. The selector 158 also supplies the buffer 159 with a signal supplied from exterior via the external pin 16 and the input buffer 157 when the setting value signal O2 output from the DDR 152 is “0”. The buffer 159 supplies the output signal of the selector 1158 to the internal bus 17 when a read signal RD for the PDR 153 is “1”.

Consequently, when the setting value signal O2 output from the DDR 152 is “1” (i.e., when the external pin 16 is used in the output mode), the setting value signal O3 output from the PDR 153 (i.e., the data set in the PDR 153) is supplied to the internal bus 17 (CPU 11) in response to the read signal RD for the PDR 153. When the setting value signal O2 output from the DDR 152 is “0” (i.e., when the external pin 16 is used in the input mode), the signal supplied from exterior via the external pin 16 and the input buffer 157 is supplied to the internal bus 17 (CPU 11).

A resource 14 has an RCR 141 (resource control register) which control the operation of the resource 14 and an AND gate 142 (interrupting circuit). The RCR 141 is connected to the internal bus 17. The setting value of the RCR 141 is set by the CPU 11. The AND gate 142 receives the resource input signal IN output from the input/output port 15, and directly receives the setting value signal O1 output from the EPCR 151 of the input/output port 15. When the setting value signal O1 output from the EPCR 151 is “1”, the AND gate 142 supplies the resource input signal IN to the interior of the resource 14. When the setting value signal O1 output from the EPCR 151 is “0”, the AND gate 142 fixes its own output signal to “0”. That is, when the setting value signal O1 output from the EPCR 151 is “0”, the AND gate 142 masks the resource input signal IN. Consequently, when the external pin 16 is used as a general-purpose input/output port (i.e., when the external pin 16 is not used as a resource input/output pin), the supply of the resource input signal IN to the resource 14 is interrupted.

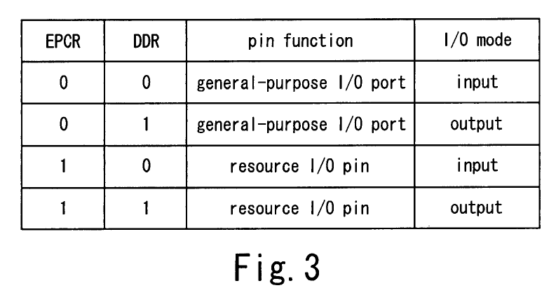

FIG. 3 shows the relationship between the register setting values of the input/output port 15 and the pin functions of the external pin. With the input/output port 15 configured as described above, the external pin 16 functions as a general-purpose input port when both the setting value of the EPCR 151 and the setting value of the DDR 152 are “0”. When the setting value of the EPCR 151 is “0” and the setting value of the DDR 152 is “1”, the external pin 16 functions as a general-purpose output port. When the setting value of the EPCR 151 is “1” and the setting value of the DDR 152 is “0”, the external pin 16 functions as a resource input pin. When both the setting value of the EPCR 151 and the setting value of the DDR 152 are “1”, the external pin 16 functions as a resource output pin.

In the microcontroller 10 having the configuration as described above, the setting value signal O1 output from the EPCR 151 (the setting value of the EPCR 151) is used directly to interrupt the supply of the resource input signal IN to the interior of the resource 14. Then, the resource 14 need not contain a register circuit for designating whether to enable or disable the supply of the resource input signal IN to the interior of the resource 14. To switch the pin function of the external pin 16 thus only requires changing the setting value of the EPCR 151. This eliminates the need for a redundant setting process. Consequently, programs to be executed by the CPU 11 are simplified with a reduction of program errors by users.

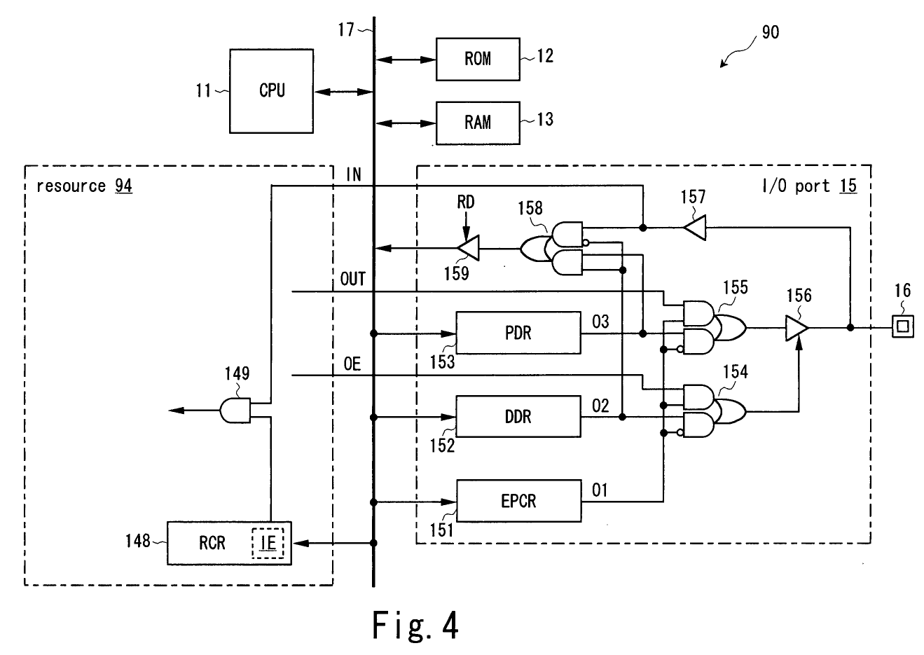

On the contrary, as shown in FIG. 4, a microcontroller 90 which the inventors have reviewed prior to the present invention has a recourse 94 whose RCR 148 has an input enabling bit IE for designating whether to enable or disable the supply of the resource input signal IN to the resource 94. Incidentally, the input enabling bit IE is set at “1” when the supply of the resource input signal IN to the resource 94 is enabled, and set at “0” when the supply of the resource input signal IN to the resource 94 is disabled. When the output signal of the input enabling bit IE is “1” (i.e., when the supply of the resource input signal IN to the resource 94 is enabled), the AND gate 149 supplies the resource input signal IN to the interior of the resource 94. When the output signal of the input enabling bit IE is “0” (i.e., when the supply of the resource input signal IN to the resource 94 is disabled), the AND gate 149 fixes its own output signal to “0”. In the microcontroller 90 having such a configuration, to switch the pin function of the external pin 16 requires a redundant setting process of changing the setting value of the input enabling bit IE before the setting value of the EPCR 151 is changed. As a result, user programs become complicated with an increase of program errors by users.

As above, according to the first embodiment, the setting value signal O1 output from the EPCR 151 is used directly to interrupt the supply of the resource input signal IN to the resource 14. Thus, the resource 14 need no longer contain a register circuit for designating whether to enable or disable the supply of the resource input signal IN to the interior of the resource 14. Consequently, the setting value of the EPCR 151 has only to be changed in order to switch the pin function of the external pin 16. This can eliminate the need for a redundant setting process, thereby contributing to simplified user programs and fewer program errors by the users.

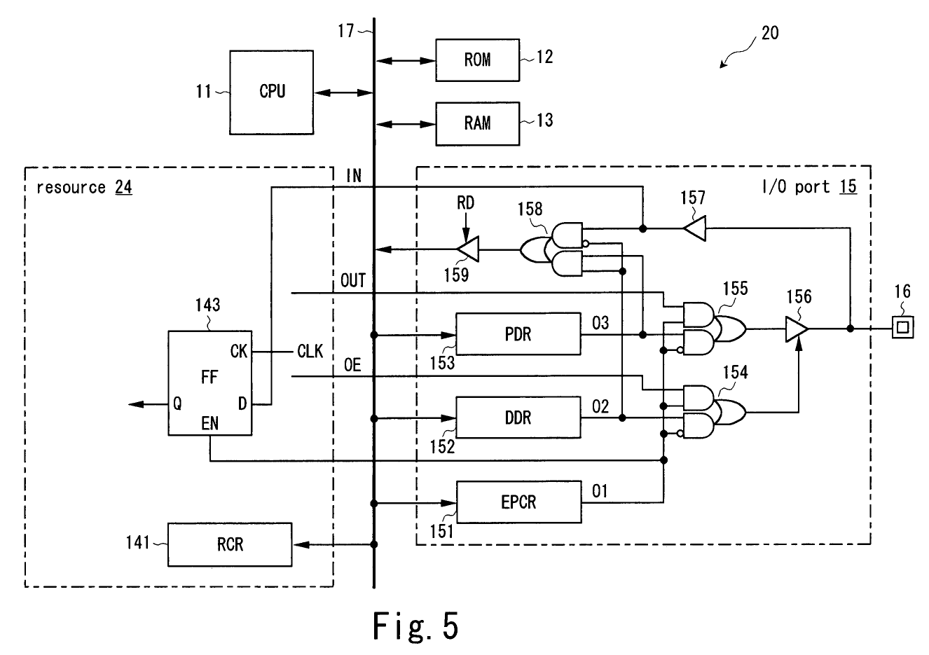

FIG. 5 shows a second embodiment of the microcontroller of the present invention. The same elements as those described in the first embodiment will be designated by identical reference numbers or symbols. Detailed description thereof will be omitted. A microcontroller 20 has resources 24 instead of the resources 14 in the microcontroller 10 of the first embodiment (FIGS. 1 and 2). In other respects, the microcontroller 20 is configured the same as the microcontroller 10 of the first embodiment is.

The resources 24 have a flip-flop 143 (interrupting circuit) with an enabling terminal EN, instead of the AND gate 142 in the resources 14 of the first embodiment. In other respects, the resources 24 are configured the same as the resources 14 of the first embodiment are. The flip-flop 143 functions as a circuit for synchronizing the resource input signal IN output from the input/output port 15 with an internal clock CLK. Here, the internal clock CLK is a clock for the resources 24 to operate in synchronization with. The internal clock CLK is supplied by a clock generator (not shown) in the microcontroller 20, for example.

When the setting value signal O1 output from the EPCR 151 of the input/output port 15 is “1”, the flip-flop 143 accepts the resource input signal IN, for example, in synchronization with the rising edge of the internal clock CLK. The accepted resource input signal IN is supplied to the interior of the resource 24. When the setting value signal 01 output from the EPCR 151 is “0”, the flip-flop 143 stops the operation of accepting the resource input signal IN. Thus, when the external pin 16 is used as a general-purpose input/output port (i.e., when the external pin 16 is not used as a resource input/output pin), the supply of the resource input signal IN to the resource 24 is interrupted. In this way, the flip-flop 143 also functions as an interrupting circuit. As above, the second embodiment can provide the same effects as those of the first embodiment. In addition, since the flip-flop 143 for synchronizing the resource input signal IN with the internal clock CLK can also be operated as an interrupting circuit, it is possible to suppress an increase in circuit scale resulting from the incorporation of an interrupting circuit.

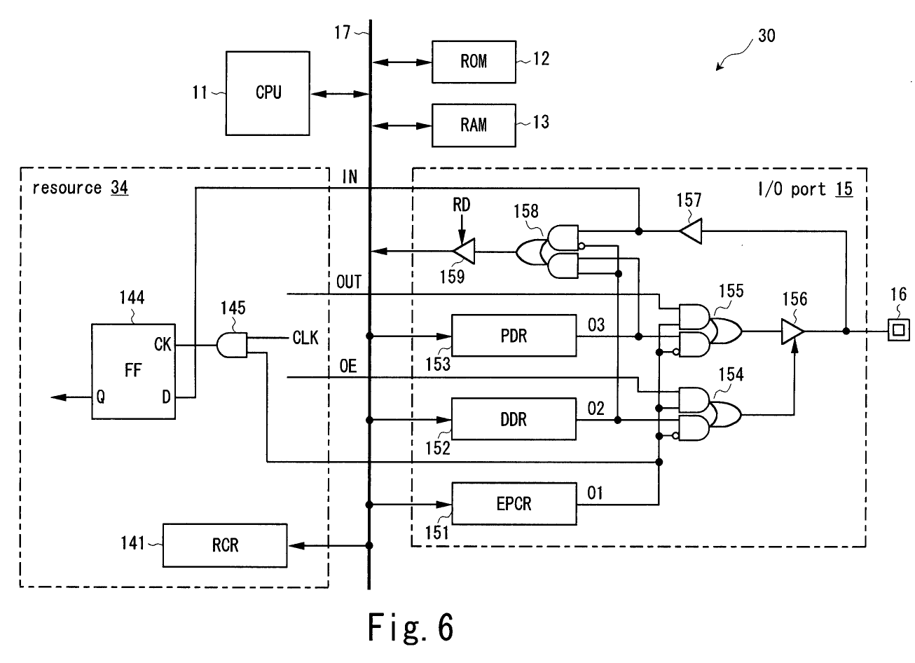

FIG. 6 shows a third embodiment of the microcontroller of the present invention. The same elements as those described in the first and second embodiments will be designated by identical reference numbers or symbols. Detailed description thereof will be omitted. A microcontroller 30 has resources 34 instead of the resources 24 in the microcontroller 20 of the second embodiment (FIG. 5). In other respects, the microcontroller 30 is configured the same as the microcontroller 20 of the second embodiment is.

The resources 34 have a flip-flop 144 and an AND gate 145 (interrupting circuit) instead of the flip-flop 143 in the resources 24 of the second embodiment. In other respects, the resources 34 are configured the same as the resources 24 of the second embodiment are. The flip-flop 144 functions as a circuit for synchronizing the resource input signal IN output from the input/output port 15 with an internal clock CLK. The flip-flop 144 accepts the resource input signal IN, for example, in synchronization with the rising edge of the internal clock CLK, and supplies the accepted resource input signal IN to the interior of the resource 34.

When the setting value signal O1 output from the EPCR 151 of the input/output port 15 is “1”, the AND gate 145 supplies the internal clock CLK to the flip-flop 144. When the setting value signal O1 output from the EPCR 151 is “0”, the AND gate 145 fixes its own output signal to “0”. That is, when the setting value signal O1 output from the EPCR 151 is “0”, the AND gate 145 masks the internal clock CLK. Consequently, when the setting value signal O1 output from the EPCR 151 is “0”, the flip-flop 144 stops the operation of accepting the resource input signal IN. As a result, when the external pin 16 is used as a general-purpose input/output port (i.e., when the external pin 16 is not used as a resource input/output pin), the supply of the resource input signal IN to the resource 34 is interrupted. In this way, the flip-flop 144 also functions as an interrupting circuit when combined with the AND gate 145.

As above, the third embodiment can provide the same effects as those of the first and second embodiments. Moreover, the AND gate 145 interrupts the supply of the internal clock CLK to the flip-flop 144 when the setting value signal O1 output from the EPCR 151 is “0”. It is therefore possible to suppress the power consumption of the microcontroller 30 when the external pin 16 is used as a general-purpose input/output port (when the external pin 16 is not used as a resource input/output pin).

Note that the first to third embodiments have dealt with the cases where the interrupting circuits such as the AND gates 142 and the flip-flops 143 are provided inside the resources. However, the present invention is not limited to such embodiments. For example, the interrupting circuits may be provided inside the input/output ports.

The invention is not limited to the above embodiments and various modifications may be made without departing from the spirit and scope of the invention. Any improvement may be made in part or all of the components.

1. A microcontroller comprising:
a functional block for receiving a functional block input signal supplied via an external pin;
an input/output port having an external port control register for outputting a setting value signal indicating a setting value in order that either a general-purpose input/output port function or a functional block input/output pin function is set to said external pin, said input/output port having a selector for connecting either a general output path or an output path of said functional block to said external pin according to said setting value signal; and
an interrupting circuit for receiving said setting value signal and interrupting supply of said functional block input signal to said functional block when said setting value signal indicates the general-purpose input/output port function.

2. The microcontroller according to claim 1, wherein
said interrupting circuit includes a gate circuit for masking said functional block input signal supplied to said functional block while receiving said setting value signal indicating the general-purpose input/output port function.

3. The microcontroller according to claim 1, wherein
said interrupting circuit includes a flip-flop for accepting said functional block input signal and supplying the accepted functional block input signal to said functional block while receiving said setting value signal indicating the functional block input/output pin function, said flip-flop stopping the operation of accepting said functional block input signal while receiving said setting value signal indicating the general-purpose input/output port function.

4. The microcontroller according to claim 1, wherein
said interrupting circuit includes a flip-flop for accepting said functional block input signal in synchronization with an internal clock and supplying the accepted functional block input signal to said functional block, and a gate circuit for masking said internal clock supplied to said flip-flop while receiving said setting value signal indicating the general-purpose input/output port function.

5. The microcontroller according to claim 1, further comprising
a CPU connected to said external port control register via an internal bus, and wherein
said setting value of said external port control register is set by said CPU.
